(19) United States
(12) Patent Application Publication
(10) Pub. No.: US 2006/0221001 A1
(43) Pub. Date: Oct. 5, 2006

(54) Display unit which converts the frame rate of image signal

(75) Inventors: Takaaki Matono, Yokohama (JP); Mutsumi Suzuki, Kodaira (JP); Toshimitsu Watanabe, Yokohama (JP); Fumio Haruna, Yokohama (JP); Katsumi Ashizawa, Yokohama (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/345,484

(22) Filed: Feb. 2, 2006

(30) Foreign Application Priority Data
Mar. 30, 2005 (JP) 2005-096700

(51) Int. Cl. G09G 3/20

(52) U.S. Cl. 345/75.2

(57) ABSTRACT

A display unit converts the image signal having the converted frame rate into an interlacing scanning format when the scanning frequency of a progressive image signal having the converted frame rate is higher than a predetermined value. The predetermined value corresponds to the maximum operation frequency of a display device or a drive circuit that drives the display device.

### TECHNICAL FIELD

The present subject matter relates to a display unit configured so as to convert the frame rate of an image signal.

### BACKGROUND

With regard to a display unit, Japanese Patent Publication No. 2003-255882 discloses that a display device (display device of an electron emission type, hereunder referred to as “FED”) shortens the drive time per frame by conversion of the frame rate of the input image signal so that its service life is extended.

In the case of the above patent document, as shown in FIG. 5 of the above JP publication, for example, the frame rate is increased quadruple, but in one mode, only one frame in four is use as a display frame. Three frames out of four are hidden, and thus the display time of the display frame is shortened. Hence, there is the possibility that screen flicker tends to be conspicuous. In particular, when the frame rate (frame frequency) of input image signal is 25 Hz like in PAL, the screen flicker is further conspicuous.

When the frame rate is increased and all the frames are used as display frames, there is the possibility that the frequency exceeds the maximum operation frequency of the display device and the drive circuit thereof. In this case, good operation of the display device cannot be attained.

Hence the needs exist for providing a display unit that makes it possible to display images of high quality while allowing good operation.

### SUMMARY

A display unit converts the image signal having the changed frame rate into an image signal having an interlacing scanning format when the scanning frequency of the image signal having the changed frame rate is higher than a predetermined value. For example, the predetermined value corresponds to the maximum operation frequency of a display device or a drive circuit that drives the display device.

According to the above described display unit, when the frame rate of the input image signal is changed so as to increase the frame rate, if the operation frequency required for the display of the frame rate changed image signal exceeds the aforementioned maximum operation frequency, it is possible to reduce the operation frequency by interlacing the image signal after frame rate change (in this case, the operation frequency decreases by half) Therefore, it is possible to make the field frequency of the image signal supplied to a display device identical to the frame frequency before interlaced while controlling the operation frequency required for the display of the image signal having the changed frame rate to a value lower than the aforementioned maximum operation frequency. It is possible to drive the display device well even when frame rate change is applied in order to reduce screen flicker.

In contrast, when the scanning frequency of an image signal after frame rate change is lower than a predetermined value, the image signal is supplied to a display device as it is in the state of the progressive scanning format without interlacing the field. Therefore, in this case, it becomes possible to reduce not only screen flicker but also linear flicker while driving the display device at a frequency not higher than the aforementioned maximum operation frequency and thus to display images of higher quality.

For example, a display device wherein cold cathode electron emissive elements are arranged in a matrix form, namely an FED, is preferred. In addition, by configuring the FED so as to be able to be compatible with both the image signal of the interlacing scanning format and the image signal of the progressive scanning format, the above described display unit makes it possible to process the conversion treatment of the scanning format corresponding to the scanning frequency of the image signal after frame rate change.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of the methodologies, instrumentalities and combinations particularly pointed out in the appended claims.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a block diagram showing a display unit of Example 1.

FIGS. 2(a), 2(b), 2(c) are schematic illustrations showing the operations of a frame rate conversion circuit and a PI conversion circuit.

FIGS. 3(a) and 3(b) are schematic illustrations explaining the operations of a frame rate conversion circuit of Example 2.

FIGS. 4(a) and 4(b) are schematic illustrations explaining the operations of an IP conversion circuit.

FIG. 5(a) and 5(b) are schematic diagrams explaining the operations of inserting antipolar pulses before and after frame rate conversion.

FIG. 6 is a flowchart showing an example of control processing of the arithmetic and control circuit 35 of Example 1.

### DETAILED DESCRIPTION

In the following detailed description, numerous specific details are set forth by way of examples in order to provide a through understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

The examples are hereunder explained referring to the drawings. Here, for the simplification of the explanations, the explanations are hereunder given by using an FED equipped with electron emissive elements as a display device wherein pixels (fixed pixels) are arranged in a matrix form. However, the display unit is not limited to the case. That is, the display unit may use a liquid crystal panel (LCD) or a plasma display panel (PDP) as the display device. However, since the FED has a high response speed and flicker tends to be more conspicuous than on other display devices, the FED is preferable for discussion purposes. Further, in the explanations of the examples below, the examples use thin-film type electron emissive elements (for example MIM type) as the electron emissive elements of the FED. However likewise, the display device is not limited to this case.

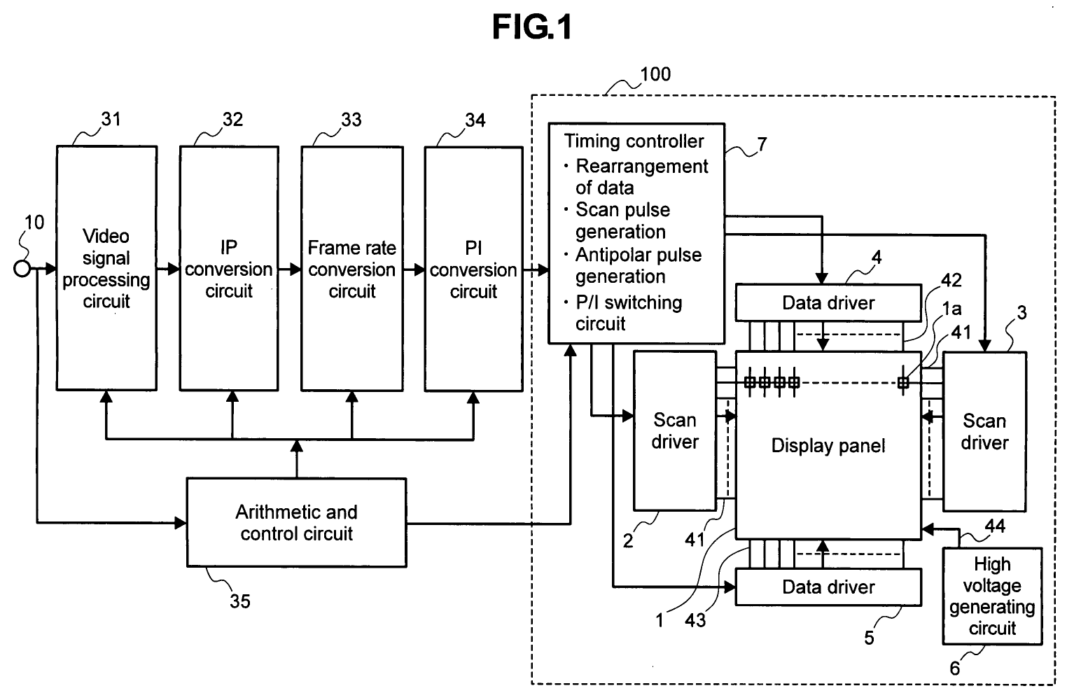

FIG. 1 is a block diagram showing a display unit according to a first example wherein an FED having thin-film type electron emissive elements is used.

Into a video signal input terminal 10, interlacing scanning format image signal including TV signal and others (for example, NTSC signal, PAL signal and others, hereunder referred to as “interlace signal”) and/or progressive scanning format image signal coming from a personal computer and the like (hereunder referred to as “progressive signal”) are input. A video signal processing circuit 31 carries out the prescribed signal processing to the image signal input into the video signal input terminal 10. When the input image signal is a TV signal, the video signal processing circuit 31 carries out the decoding of the TV signal too. The signal output from the video signal processing circuit 31 is supplied to an IP (interlace to progressive) conversion circuit. When the input image signal is an interlace signal, the IP conversion circuit 32 converts the interlace signal into progressive signal (hereunder the conversion processing is referred to as “IP conversion”). When the input image signal is a progressive signal, the input image signal passes thorough the IP conversion circuit 32. In the other word, the IP conversion circuit 32 does not carries out the IP conversion.

A frame rate conversion circuit 33 receives the signal output from the IP conversion circuit 32 and changes it so as to increase the frame frequency (frame rate) of the input progressive signal. (Hereunder the frame rate change processing is referred to as “frame rate conversion”.) A PI (progressive to interlace) conversion circuit 34 converts the progressive signal having the converted frame rate in the frame rate conversion circuit 33 into interlace signal (hereunder the conversion processing is referred to as “PI conversion”). The PI conversion circuit 34 operates when the frame rate of the input progressive signal is judged to be over the maximum operation frequency of a display device 100. An arithmetic and control circuit 35 is a circuit that carries out the system control of a display unit in accordance with programs stored therein and comprises, for example, a CPU and others.

The arithmetic and control circuit 35 receives the image signal input into the video signal input terminal 10, judges the signal type of the image signal, such as NTSC signal, PAL signal or others, and detects frame frequency (fr)/field frequency (fi) of the input image signal. That is, the arithmetic and control circuit 35 detects, for example, fr=30 Hz/fi=60 Hz in the case of NTSC signal and fr=25 Hz/fi=50 Hz in the case of PAL signal. Further, the arithmetic and control circuit 35 judges whether the input image signal is an interlace signal or a progressive signal and controls the operation of the IP conversion circuit 32. For example, when the input image signal is interlace signal, the arithmetic and control circuit 35 controls the IP conversion circuit 32 so as to apply IP conversion to the interlace signal. On the other hand, when the input image signal is progressive signal, the arithmetic and control circuit 35 lets the progressive signal pass through so as not to apply IP conversion.

Furthermore, the arithmetic and control circuit 35 controls the frame rate conversion processing of the frame rate conversion circuit 33 so as not to reduce screen flicker.

In addition, the arithmetic and control circuit 35 contains a nonvolatile memory (hereunder referred to as “RAM”) and the RAM stores beforehand the maximum operation frequency of the display device 100. The arithmetic and control circuit 35 compares the maximum operation frequency stored in the RAM with the scanning frequency (in this example, vertical scanning frequency) of the image signal after the frame rate conversion in the frame rate conversion circuit 33, and judges whether or not the scanning frequency exceeds the maximum operation frequency. Then, when the arithmetic and control circuit 35 judges that the scanning frequency of the image signal having the converted frame rate exceeds the maximum operation frequency, it controls the PI conversion circuit 34 so as to apply PI conversion to the image signal having the converted frame rate. In contrast, when the scanning frequency of the image signal having the converted frame rate does not exceed the maximum operation frequency, the arithmetic and control circuit 35 controls the image signal having the converted frame rate so as not to be subjected to PI conversion and so as to pass through in the state of the progressive signal. A sequence of the above processes is applied in accordance with a program in a ROM, which is not shown the figure, contained in the arithmetic and control circuit 35.

The display device 100 can display both the progressive signal and the interlace signal and, in this example, is equipped with an electron emission type display panel wherein cold cathode type electron emissive elements are arranged in a matrix form. An example of the configuration of the display device 100 is explained here.

The display device 100 has a display panel 1 wherein plural thin-film type electron emissive elements la are arranged in a matrix form, scan drivers 2 and 3 and data drivers 4 and 5 which drive the display panel 1, a high voltage generating circuit 6 which generates accelerating voltage of a high voltage that is applied to the display panel 1, and a timing controller 7 which controls the scan drivers 2 and 3 and data drivers 4 and 5 on the basis of the input image signal input into the display device 100.

The display panel 1 is a passive matrix type display panel and has a rear substrate (not shown in the figure) and a front substrate (not shown in the figure) facing each other. On the rear substrate, plural data lines 42 and 43 extending in the columnar direction (vertical direction on the screen) are arranged in the row direction (horizontal direction on the screen) and plural scanning lines 41 extending in the row direction are arranged in the columnar direction. Then, by disposing electron emissive elements (for example, thin-film type electron emissive elements of an MIM type or the like) la at the intersections of the plural data lines and the plural scanning lines, the plural electron emissive elements la are arranged in a matrix form. On the front substrate, fluorescent material not shown in the figure is disposed opposite each of the electron emissive elements.

The scan drivers 2 and 3 are connected to the scanning lines 41 of the display panel 1. The reason why the scan drivers 2 and 3 are disposed on the right and left sides is to reduce the inclination of luminance caused by the voltage drop generated by the resistance of the scanning lines. Thus the system is designed so as to supply scan pulses to the scanning lines 41 simultaneously on both the right and left sides. Here, as the scan pulses applied to scanning lines, there are line selection pulses to select the scanning lines and antipolar pulses applied simultaneously to all the scanning lines during non-display period which will be described later.

The scan drivers 2 and 3 apply selection signal to select plural electron emissive elements 1a for each row unit (one or two rows per unit) sequentially to the scanning lines in the columnar direction on the basis of the line selection pulses coming from the timing controller 7. Thereby the row selecting operation is carried out one after another.

Further, the data lines of the display panel 1 are divided into the upper and lower regions of the screen on the display panel in order to reduce error illumination generated by pulse noise caused by the coupling capacitance between the scanning lines and data lines. Then the upper and lower regions of the screen are driven separately from each other. The data driver 4 is connected to the data lines 42 in the upper region of the screen and the data driver 5 is connected to the data lines 43 in the lower region of the screen.

The data drivers 4 and 5 operate on the basis of the image data coming from the timing controller 7 in accordance with the row selection by the scan drivers 2 and 3. Then, with regard to the electron emissive elements of each row, the data driver 4 or 5 supplies driving signal based on each input image signal to the data lines 42 or 43. Further, the data drivers 4 and 5 maintain the data of one row on the display panel 1, namely the image data of one line coming from the timing controller 7, for one horizontal time period on the basis of the timing signal (horizontal synchronizing signal, clock signal having the clock frequency corresponding to the definition of the display panel) coming from the timing controller 7, and rewrite the data in each horizontal cycle. Here, the driving signal are supplied from the data driver 4 during the display period of the upper region of the screen and from the data drive 5 during the display period of the lower region of the screen.

In the meantime, though the display device 100 uses electron emissive elements and usually adopts progressive display as described earlier, the present example is also compatible with the interlace display that allows the operation frequency to be lower than that of the progressive display. Hence, the timing controller 7 has the function of switching between progressive and interlace (hereunder referred to as “P/I switching unit”). When the arithmetic and control circuit 35 instructs the display device 100 to make interlace display, the P/I switching unit receives the instruction and controls the output timing of the aforementioned line selection pulses. That is, when instructed to make the interlace display, the timing controller 7: generates, for example, line selection pulses to select odd-numbered scanning lines in an odd-numbered field and line selection pulses to select even-numbered scanning lines in an even-numbered field; and supplies them to the scan drivers 2 and 3. The timing controller 7, in synchronous with the output operation of the line selection pulses, supplies image data corresponding to row selection by the scan drivers 2 and 3 to the data drivers 4 and 5. Thereby it is possible to realize interlace display on the display panel 1. Here, it is assumed that the display panel 1 is divided into two regions; the upper screen region and the lower screen region. The timing controller 7 carries out the rearrangement of pixel data to display an image separately in the upper and lower screen regions.

The high voltage generating circuit 6 to generate accelerating voltage of a high voltage (7 kV for example) is connected to the anode line 44 of the display panel 1. The role of the accelerating voltage is to accelerate electrons discharged from the electron emissive elements la disposed on the rear substrate toward the front substrate on which fluorescent material is disposed.

Operations regarding display on the display panel are hereunder explained. When driving signals are given to the electron emissive elements la of one row, to which selection signals have been applied (namely selected) through the scanning lines 41 by the aforementioned scan drivers 2 and 3, from the data drivers 4 and 5 through the data lines 42 and 43, the electron emissive elements of the relevant row discharge electrons in the respective amounts corresponding to the electric potential difference between the aforementioned selection signal and the driving signal at each pixel. The level of the selection signal applied at the time of selection is constant without regard to the locations of the electron emissive elements. Hence, the amount of electrons discharged from the electron emissive elements varies in accordance with the levels of the driving signal (that is, the amount is determined by the level of image signal which is the basis of the driving signal at each pixel). Then the accelerating voltage (7 kV for example) supplied from the high voltage generating circuit 6 is applied to the anode line 44 of the display panel 1. Thereby, the electrons discharged from the electron emissive elements are accelerated by the accelerating voltage and collide with the fluorescent material disposed on the front substrate, not shown in the figure, of the display panel 1. The fluorescent material is excited by the collision with the accelerated electrons and produces luminescence. Thereby, the image of one selected horizontal line is displayed.

Further, in the case of progressive display, with regard to plural scanning lines, the scan drivers 2 and 3 select electron emissive elements on a row-to-row basis by applying selection signal sequentially in the columnar direction. In contrast, in the case of interlace display, they select electron emissive elements of an odd-numbered or even-numbered row alternately from field to field. By so doing, it is possible to form the image of one frame or one field on the screen of the display panel 1.

Meanwhile, in the present example, the timing controller 7 also has the function of generating antipolar pulses and supplying them to the scan drivers 2 and 3. The antipolar pulses play the roles of reversing the direction of the drive voltage of the electron emissive elements from the direction of usual operations and discharging the electric charge accumulated in the insulating layers (electron accelerating layers) in the electron emissive elements. The scan drivers 2 and 3, when they receive the antipolar pulses from the timing controller 7, apply the antipolar pulses to all the scanning lines simultaneously for example during the period of the non-display of image signal (for example vertical blanking period). Thereby the direction of the drive voltage applied to the electron emissive elements is reversed from the direction of usual operations and the electrons in the electron emissive elements move toward the opposite direction from the direction of the fluorescent material. Hence, by the present example, it is efficiently to well discharge the electric charge accumulated in the electron emissive elements, mitigate the deterioration of the electron emissive elements, and extend the service life of the electron emissive elements.

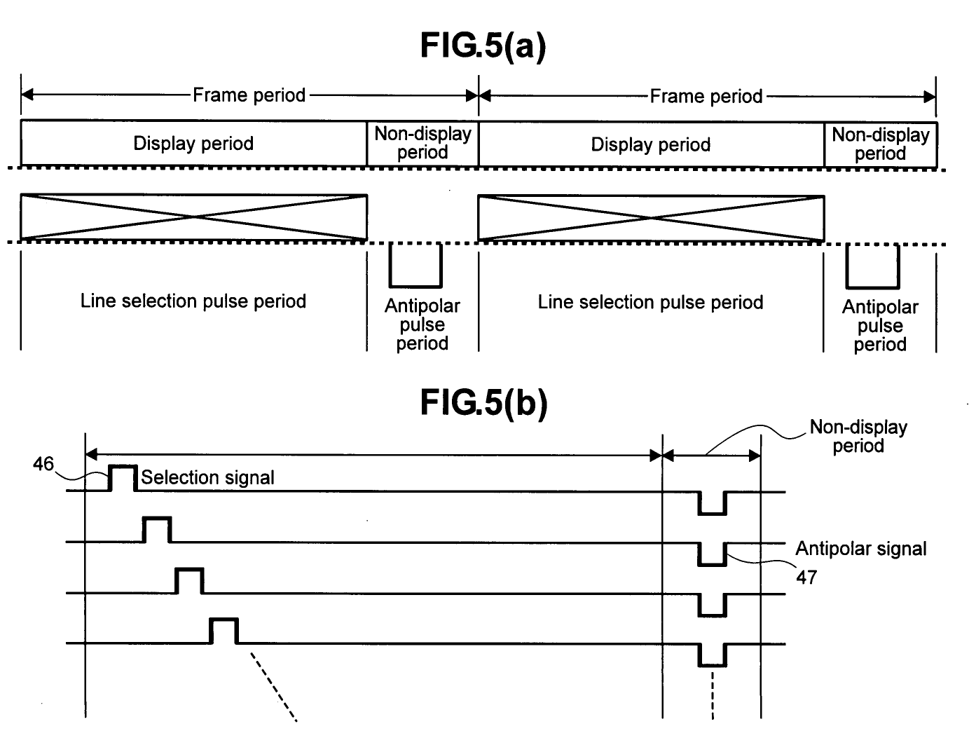

FIGS. 5(a) and 5(b) schematically show the relationship between the display period/non-display period and the line selection pulse period/antipolar pulse period in one frame period in the case of progressive display. FIG. 5(a) is a schematic diagram showing the relationship between the display period/non-display period and the line selection pulse period/antipolar pulse period in one frame period, and FIG. 5(b) is a diagram showing the waveforms of the line selection pulses and the antipolar pulses in operations. These drawings represent the time when progressive display is carried out on a display screen for the simplification of explanations.

As shown, in the period of displaying an image in one frame period of the image, the scan drivers 2 and 3 shift the selection signal (line selection pulses) 46 row by row (line by line) sequentially from the scanning lines of the screen upper part in the columnar direction in order to select the electron emissive elements of each row. In contrast, in the vertical non-display period (blanking period in the vertical direction) of an image, antipolar pulses having the polarity different from that of the selection signal are supplied from the timing controller 7 to the scan drivers 2 and 3. The scan drivers 2 and 3 apply antipolar pulses 47 to all the scanning lines at the same time and discharge the electric charge accumulated in the insulating layers in the electron emissive elements.

In this way, by applying antipolar pulses during a non-display period, it is possible to discharge the electric charge accumulated in the insulating layers in the electron emissive elements and extend the service life of the electron emissive elements. In the present example, as stated above, the signal processing of increasing the ratio frame frequency/field frequency is applied and hence there is a danger that the accumulation of electric charge increases in the insulating layers and the service life further shortens. In the present example however, it is designed so as to insert antipolar pulses after IP conversion or after frame rate conversion and hence the accumulated electric charge is discharged in each increased frame or field. As a consequence, by the present example, it is possible to prevent the service life from shortening even when the ratio frame frequency/field frequency is increased.

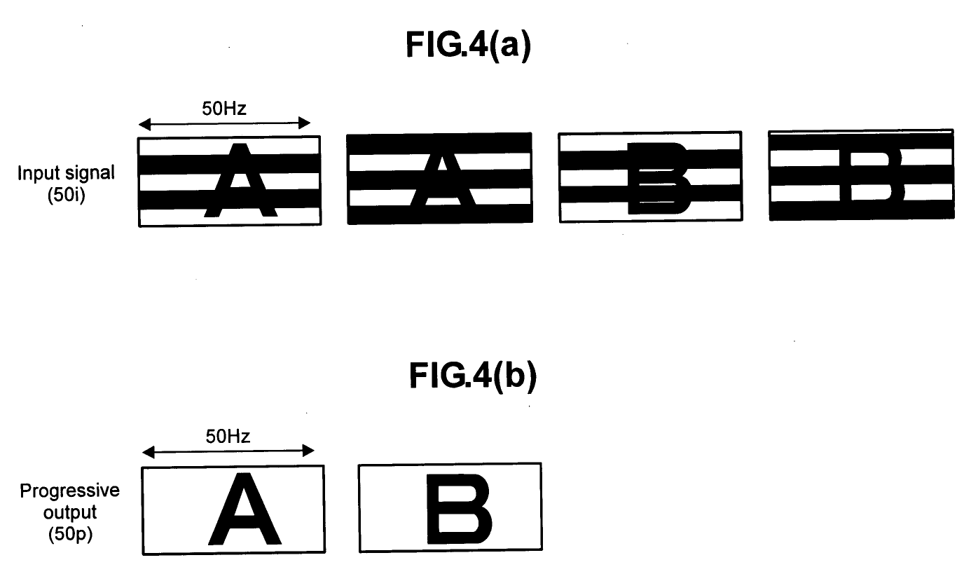

Next, FIGS. 4(a) and 4(b) schematically show the operations of IP conversion. In FIG. 4(a), in order to facilitate the schematic illustration, the number of the horizontal scanning lines is set at five and the horizontal scanning lines for display are represented by the white lines. IP conversion is the processing to convert PAL signal (50i) of frame frequency (fr) 25 Hz/field frequency (fi) 50 Hz as shown in FIG. 4(a) into the progressive signal (50p) of the frame frequency (fr) 50 Hz as shown in FIG. 4(b), for example, by a known means such as double writing, interpolation or the like.

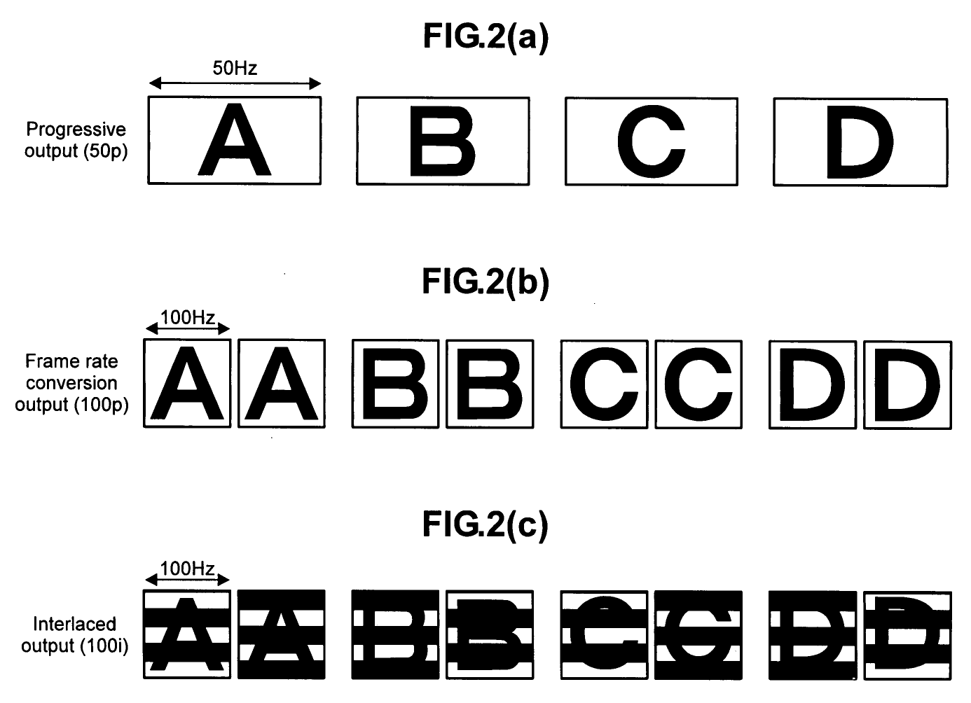

Next, the operations of the frame rate conversion circuit 33 and the PI conversion circuit 34 are explained. FIG. 2 comprises schematic illustrations showing the operations of the frame rate conversion circuit 33 and the PI conversion circuit 34 according to the present example. FIG. 2(a) represents output images of the IP conversion circuit, FIG. 2(b) output images of the frame rate conversion circuit, and FIG. 2(c) output images of the PI conversion circuit. Here, it is assumed that the output signal of the IP conversion circuit 32 is progressive signal (PAL signal) having the frame frequency of 50 Hz as shown in FIG. 2(a). The frame rate conversion circuit 33 converts the progressive signal into image signal having the frame frequency of, for example, 100 Hz by doubling the frame frequency of 50 Hz as shown in FIG. 2 (b). In the present example, it is assumed that the frame rate conversion circuit 33 carries out the operation of doubling the frame frequency by displaying an identical image continuously twice as shown in FIG. 2(b). However, it is also acceptable to produce a new frame from the information of anteroposterior frames, insert the new frame into the original image signal, and double the frame frequency. It is possible to inhibit screen flicker by doubling the frame frequency. In addition, since IP conversion is also applied in the present example, the line flicker can also be reduced.

In general, in the case of a display unit using fixed pixels, when the frame frequency is doubled, the operation frequency of a circuit is also doubled. Therefore, it sometimes happens that the operation frequency necessary for image display in the case of doubling the frame frequency exceeds the upper limits of the operation frequencies of the drive circuits, such as the data drivers 4 and 5, and the display panel. The phenomenon is explained taking as an example the case of displaying PAL signal having the frame frequency of 100 Hz (hereunder referred to as “100p signal”), which having been subjected to IP conversion and frame rate conversion, on a display panel having the definition of 1,366 horizontal pixels and 768 vertical pixels. In this case, the clock frequency (the frequency of the clock signal supplied to the data drivers 4 and 5) necessary for the display of the lOOp signal is about 136MHz in consideration of the blanking part of an image. Here, when the upper limit of the clock frequency, i.e., maximum operation frequency that can be handled by the data drivers 4 and 5 is 90 MHz for example, the clock frequency necessary for the display of the 100p signal largely exceeds the maximum operation frequency and good display operations cannot be secured.

In such a case, in the present example, as shown in FIG. 2(c), with regard to the 100p signal, for example, an odd-numbered field is produced by thinning the even-numbered horizontal scanning lines in a certain frame and then an even-numbered field is produced by thinning the odd-numbered horizontal scanning lines in the next frame. By repeating such processing alternately, the two fields compose one frame. That is, in the present example, the signal being subjected to progressive conversion and further having an increased frame rate is converted into interlace signal under specific conditions (namely, when the clock frequency necessary for the display of such signal exceeds the maximum operation frequencies of the drive circuits and the display panel). As a consequence, the 100 p signal is converted into interlace signal and the clock frequency necessary for the display of the signal is about 68 MHz which is a half of 136 MHz which is the clock frequency necessary for the display of the 100p signal. The frequency is lower than 90 MHz; the maximum operation frequency that can be handled by the data drivers 4 and 5, and hence good display operations are secured.

As stated above, in the present example, by converting progressive signal into interlace signal through PI conversion, the frame frequency thereof is converted into the field frequency (100 HZ) that is the same frequency as the frame frequency (100 Hz) after frame rate conversion, the scanning frequency of the image signal is reduced to a half, and thus operations are carried out within the operation frequencies of circuits and the operation frequency of a display panel. The field frequency after PI conversion is still 100 Hz which is the same frequency as the frame frequency after the frame rate conversion and thus screen flicker is reduced. Further, the scanning frequency of the image signal can be reduced and hence it is possible to efficiently operate the drive circuits and the display panel.

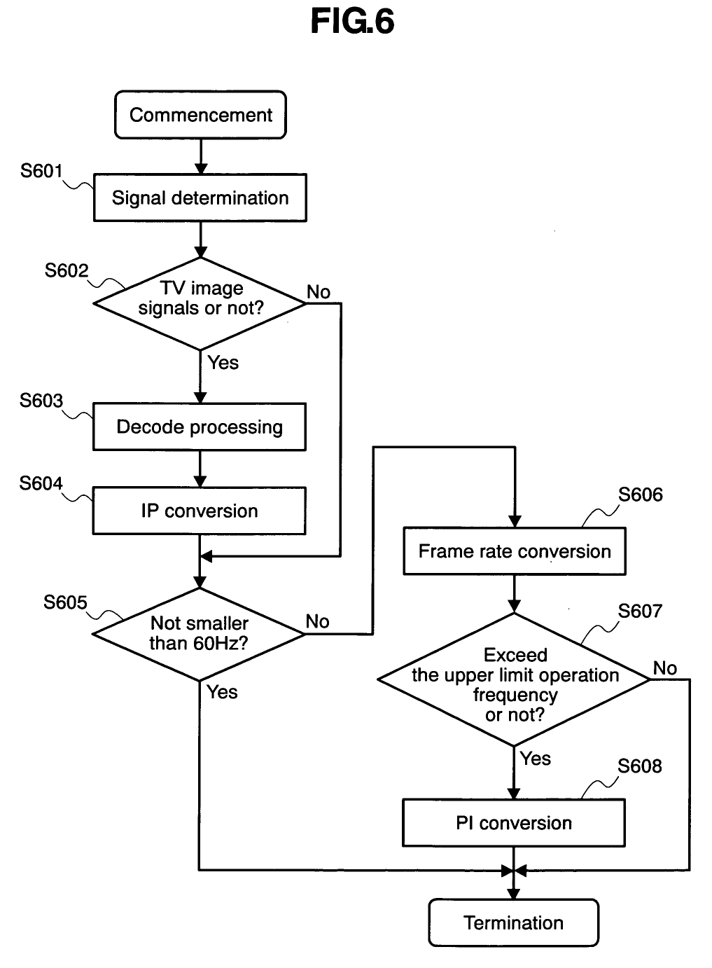

The aforementioned decode processing, IP conversion and frame rate conversion of TV signal are controlled by the arithmetic and control circuit 35. The control processing is hereunder explained while referring to the flowchart shown in FIG. 6.

The arithmetic and control circuit 35, when it starts control processing, firstly determines the input image signal at Step (hereunder “Step” is referred to as “S”) 601, and stores the type of the signal, frame frequency, field frequency, and other parameters in a RAM in the arithmetic and control circuit 35. Thereafter, whether or not the input image signal is a TV signal is judged at S602. If the input image signal is a TV signal which is an interlaced signal, for example a PAL signal (interlace signal having the frame frequency of 25 Hz), the PAL signal is subjected to decode processing in the video signal processing circuit 31 (S603) and subjected to IP conversion in the IP conversion circuit 32, and the frame frequency is set at 50 Hz (S604), and then the processing advances to S605. In contrast, if the input image signal is judged not to be a TV signal (for example, to be a progressive signal coming from a personal computer or the like) at S602, it is subjected to prescribed signal processing in the video signal processing circuit 31, goes through the IP conversion circuit 32, and processing advances to S605.

At S605, the frame frequency of the progressive signal input into the frame rate conversion circuit 33 is computed from the type of signal, the frame frequency and/or the field frequency of the input image signal stored in the RAM. The frame frequency of the progressive signal may also be detected actually. Then at S605, whether or not the frame frequency of the progressive signal computed or detected is not less than 60 Hz which is regarded as the level where screen flicker is hardly conspicuous is judged. If the answer is “no,” then the signal processing advances to S606 and to produce the converted frame rate (rate doubled) in the frame rate conversion circuit 33, and thus the frame frequency of the progressive signal is set at 100 Hz. At S607, the scanning frequency of the image signal after frame rate conversion is obtained and is compared with the frequency stored beforehand in the RAM. Then whether or not the obtained scanning frequency exceeds the stored frequency is judged. Here, it is assumed that the frequency in the RAM corresponds to the upper limit of the operable frequencies of the display panel 1/data drivers 4 and 5. In the present example, it is assumed that the obtained scanning frequency of the image-signal after frame rate conversion is a vertical scanning frequency. This is because, since the definition of the display panel 1 is known beforehand, if the vertical scanning frequency of the image signal after frame rate conversion is determined, the operation frequency necessary for the display of the relevant image signal is uniquely decided.

If the result of the judgment at S607 is “yes” (if the scanning frequency is judged to be larger than the upper limit of the operation frequency of the display device 100), at S608, the image signal having the converted frame rate are converted into interlace signal in the PI conversion circuit 34. Thereby it is possible to lower the operation frequency and display the image signal on the display device 100. Then the display device 100 (timing controller 7) is controlled so-as to carry out the interlace display and then the processing is terminated. On the other hand, if the result of the above judgment is “no” at S607, it is possible to display the image signal having the converted frame rate as they are on the display device 100 and hence the processing is terminated without the application of the PI conversion. Further, if the result is “yes” at S605, since screen flicker does not occur, the signal is not subjected to the frame rate conversion and PI conversion and passes through, and then the processing is terminated.

Here, it goes without saying that the arithmetic and control circuit 35 sequentially determines the type of signal when and after the power source is activated and, when the type of the signal is changed, the aforementioned control processing is properly carried out.

As stated above, by the present-example, when there is a risk of generating screen flicker even after IP conversion, the frequency is converted into a frame frequency that makes screen flicker hardly conspicuous. When the scanning frequency of the image signal exceeds the upper limit of the operation frequency of the display screen at the frame rate conversion, the image signal are converted into the interlace signal having the field frequency of the same frequency as the frame frequency after frame rate conversion. Thereby it is possible to carry out good display operations while screen flicker is reduced.

The present example makes it possible to display high quality images having reduced screen flicker while well operating a display device.

In the case of above Example 1, the explanations are given taking as an example the case wherein a PAL signal is subjected to IP conversion and the frame frequency is changed from 50 Hz to 100 Hz of an integral multiple (twice) through frame rate conversion at the frame rate conversion circuit. However, it is also acceptable to convert the frame frequency after IP conversion from 50 Hz to a frame frequency of a non-integral multiple that makes screen flicker hardly conspicuous, for example 60 Hz. The next example involves converting the frame frequency from 50 Hz to 60 Hz and is hereunder explained in detail.

Here, the display unit of the present example has the same circuit configuration as Example 1 shown in FIG. 1 and the flow of processing in the arithmetic and control circuit 35 is also identical to the contents of the flowchart shown in FIG. 6. In this light, the detailed explanations on the portions that overlap with Example 1 are omitted and explanations are given only to the different points. Further, in the following explanations, the details of Example 2 are explained taking the case wherein PAL signal are input into a display unit as an example.

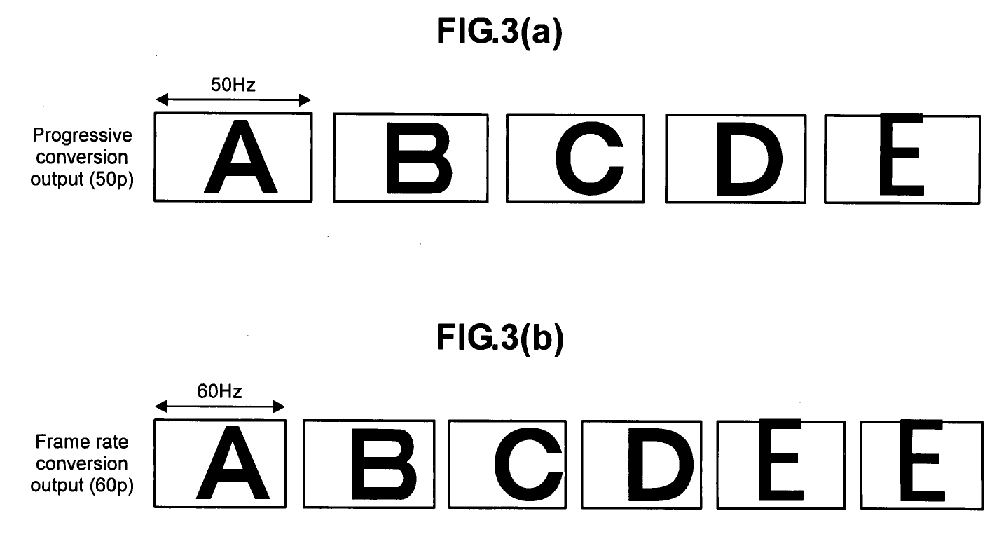

FIGS. 3(a) and 3(b) comprise schematic illustrations explaining the operations of a frame rate conversion circuit according to the present example. FIG. 3(a) is the output image of an IP conversion circuit and FIG. 3(b) is the output image of a frame rate conversion circuit. When PAL signal having the frame rate (frame frequency) of 25 Hz are input, in the same way as Example 1, an arithmetic and control circuit 35 computes the frame frequency of the progressive signal after IP conversion from the type of the signal, the frame frequency and the field frequency. The frame frequency of the progressive signal after IP conversion may also be detected. actually. Then whether or not the frame frequency of the computed or detected progressive signal is not less than 60 Hz that makes screen flicker hardly conspicuous is judged. The frame frequency of this case is 50 Hz and hence it is judged that screen flicker occurs. Therefore, the arithmetic and control circuit 35 controls the frame rate conversion circuit 33 so as to change the frame frequency after IP conversion from 50 Hz to 60 Hz through frame rate conversion.

To that end, the frame rate conversion circuit 33 changes the frame frequency of the input progressive signal (50p) from 50 Hz to 60 Hz. The frame rate conversion at this time is carried out through such processing as shown in FIG. 3 for example. That is, when five pieces of frames of progressive signal (50p) are to be displayed with the frame frequency of 60 Hz, one frame ( 1/60 sec.) is not filled and thus the fifth frame image is added as the additional sixth frame image so as to maintain the continuity of the frame images. Thereby the frame frequency is changed from 50 Hz to 60 Hz (60p). Needless to say, it is also acceptable to produce an interpolating frame from the information of the anteroposterior frames (the fifth and sixth frames) and insert it between the fifth and sixth frames without continuously using the identical frame (the fifth frame).

Since there is no possibility that the frame frequency 60 Hz of the progressive signal exceeds the maximum operation frequency of the display device 100, it is not necessary to operate the PI conversion circuit and the signal passes through. In this case too, the timing controller 7 inserts antipolar pulses during the non-display period of the image signal converted into 60 Hz. Thereby the service life of the display panel 1 can be prolonged even in this case.

As stated above, by the present example, it is possible to properly reduce screen flicker while reducing the possibility of exceeding the upper limit of the operation frequency of the display screen, which possibility is caused by changing the frame frequency double from 50 Hz to 100 Hz through frame rate conversion. Needless to say, even in this case, when there is a possibility that the operation frequency necessary for the display of image signal having the converted frame rate exceeds the aforementioned upper limit of the operation frequency, the image signal having the converted frame rate may be converted into interlace signal.

While the foregoing has described what are considered to be the best mode and/or other examples, it is understood that various modifications may be made therein and that the subject matter disclosed herein may be implemented in various forms and examples, and that the teachings mat be applied in numerous applications, only some of which have

1. A display unit comprising:
a frame rate conversion circuit which changes a frame rate of an image signal having a non-interlacing scanning format;
a signal conversion circuit which converts the image signal having the non-interlacing scanning format outputted from the frame rate conversion circuit into an image signal having an interlacing scanning format when the scanning frequency of the image signal having the changed frame rate is higher than a predetermined value; and
a display device which displays an image based on the image signal having an interlacing scanning format.

2. A display unit according to claim 1, wherein the image signal having the non-interlacing scanning format has a progressive scanning format; and wherein the signal conversion circuit does not convert into the interlacing scanning format when the scanning frequency of the image signal having the converted frame rate conversion is lower than the predetermined value.

3. A display unit according to claim 1, wherein the display device has electron emissive elements arranged in a matrix form and is compatible with an image signal having the interlacing scanning format and an image signal having the progressive scanning format.

4. A display unit according to claim 1, wherein the scanning frequency of the image signal having the changed frame rate is a vertical scanning frequency.

5. A display unit comprising:
a progressive conversion circuit which converts an input image signal into an image signal having a progressive scanning format when the input image signal has an interlacing scanning format;
a frame rate conversion circuit which increases a frame rate of the image signal outputted from the progressive conversion circuit;
an interlace conversion circuit capable of converting the image signal outputted from the frame rate conversion circuit into the image signal having an interlacing scanning format; and
a display device which displays an image based on the image signal outputted from the interlace conversion circuit;
wherein the interlace conversion circuit converts the image signal outputted from the frame rate conversion circuit into the image signal having the interlacing scanning format when the scanning frequency of the image signal outputted from the frame rate conversion circuit is higher than a predetermined value.

6. A display unit according to claim 5, wherein the interlace conversion circuit does not convert the image signal outputted from the frame rate conversion circuit into the image signal having the interlacing scanning format when the scanning frequency of the image signal outputted from the frame rate conversion circuit is lower than the predetermined value.

7. A display unit according to claim 5, wherein the input image signal is supplied to the frame rate conversion circuit without the progressive scanning conversion processing by the progressive conversion circuit when the input image signal has the progressive scanning format,

8. A display unit according to claim 5, wherein the frame rate conversion circuit increases the frame rate of image signal outputted from the IP conversion circuit to twice the frame rate of the input image signal.

9. A display unit according to claim 5, wherein the display device has electron emissive elements arranged in a matrix form and is compatible with an image signal having the interlacing scanning format and an image signal having the progressive scanning format.

10. A display unit comprising:
a display device having a plurality of scanning lines; a plurality of data lines intersecting with the scanning lines, and a plurality of electron emissive elements disposed at the intersections of the scanning lines and data lines;
a progressive conversion circuit which converts an input image signal into an image signal having a progressive scanning format when the input image signal has an interlacing scanning format;
a frame rate conversion circuit which increases the frame rate of the image signal outputted from the progressive conversion circuit;
an interlace conversion circuit capable of converting the image signal outputted from the frame rate conversion circuit into an interlacing scanning format;
a scan driver which supplies a selection signal for selecting at least one of the plurality of scanning lines to the scanning lines;
a data driver which produces a driving signal based on the image signal outputted from the interlace conversion circuit and which supplies the driving signal to the data lines; and
a controller which controls the conversion processing of scanning formats by the interlace conversion circuit in accordance with the scanning frequency of the image signal outputted from the frame rate conversion circuit and the output operation of the selection signal by the scan drivers.

11. A display unit according to claim 10, wherein:
the controller controls the interlace conversion circuit to carry out the conversion processing of scanning formats in a first state wherein the scanning frequency of the image signal outputted from the frame rate conversion circuit is higher than a predetermined value; and
the controller controls to the interlace conversion circuit not to carry out the conversion processing of scanning formats in a second state wherein the scanning frequency of the image signal outputted from the frame rate conversion circuit is lower than the predetermined value.

12. A display unit according to claim 11, wherein the controller controls the scan drivers to output the selection signal for the interlacing scanning of the scanning lines in the first state, and to output the selection signal for the progressive scanning of the scanning lines in the second state.

13. A display unit according to claim 10, wherein:
the progressive conversion circuit doubles the number of scanning lines in a vertical display period of the input image signal;
the frame rate conversion circuit doubles the frame rate of the image signal outputted from the progressive conversion circuit; and
the interlace conversion circuit halves the number of scanning lines in the vertical display period of the image signal outputted from the frame rate conversion circuit.

14. A display unit, comprising:
a frame rate conversion circuit which converts a frame rate of an input image signal;
a display device which displays an image based on the image signal having the converted frame rate; and
a display driver which controls operation frequency of the display device;
wherein the frame rate conversion circuit changes the frame rate such that a frequency of processing required by the image signal having the converted frame rate is not higher than a maximum operation frequency of the display driver.

15. An image displaying method comprising the steps of:
changing a frame rate of an input image signal having a non-interlacing scanning format;
converting the image signal having the changed frame rate and the non-interlacing scanning format into an image signal having an interlacing scanning format when the scanning frequency of the image signal having the changed frame rate and the non-interlacing scanning format is higher than a predetermined value; and
displaying an image based on the image signal having the interlacing scanning format.

16. An image displaying method comprising:
converting an input image signal into an image signal having a progressive scanning format when the input image signal has an interlacing scanning format;
increasing a frame rate of the image signal having the progressive scanning format;
converting the image signal having the increased frame rate and the progressive scanning format into an image signal having an interlacing scanning format; and
displaying an image based on the image signal having the interlacing scanning format at the increased frame rate;
wherein the image signal having the increased frame rate is converted into the image signal having the interlacing scanning format when the scanning frequency of the image signal having the increased frame rate is higher than a predetermined value.

17. A method for displaying an image on a display device having a plurality of scanning lines, a plurality of data lines intersecting with the scanning lines, and a plurality of electron emissive elements disposed at the intersections of the scanning lines and data lines, comprising:
converting an input image signal into an image signal having a progressive scanning format when the input image signal has an interlacing scanning format;
increasing a frame rate of the image signal having the progressive scanning format;
converting the image signal having the increased frame rate and the progressive scanning format into an image signal having an interlacing scanning format at the increased frame rate;
supplying a selection signal for selecting at least one of the plurality of scanning lines to the scanning lines;
producing a driving signal based on the image signal having the interlacing scanning format at the increased frame rate;
supplying the driving signal to the data lines; and
controlling the interlacing conversion processing in accordance with the scanning frequency of the image signal having the increased frame rate and the supplying operation of the selection signal.

18. An image displaying method, comprising:
changing a frame rate of an input image signal;
displaying an image on a display device based on the image signal having the converted frame rate; and
controlling an operation frequency of the image signal having the converted frame rate so as not to be higher than a maximum operation frequency of the display driver.
